(19) United States
(12) Patent Application Publication
(10) Pub. No.: US 2015/0081195 A1
(43) Pub. Date: Mar. 19, 2015

(54) METHOD FOR CONTROLLING FUEL INJECTION AND FUEL INJECTION SYSTEM

(71) Applicant: Ford Global Technologies, LLC, Dearborn, MI (US)

(72) Inventors: Oliver Berkemeier, Bergisch Gladbach (DE); Jens Wojahn, Bergisch Gladbach (DE); David van Bebber, Aachen (DE); Klemens Grieser, Langenfeld (DE); Uwe Reuter, Roetgen (DE)

(21) Appl. No.: 14/469,502

(22) Filed: Aug. 26, 2014

(30) Foreign Application Priority Data
Sep. 13, 2013 (DE) 102013218358.5

(51) Int. Cl. F02D 41/38; G05D 16/02; F02D 41/14

(52) U.S. Cl. CPC F02D 41/3863; F02D 41/1401; G05D 16/02
USPC 701/104; 137/14

(57) ABSTRACT

A system and method for controlling fuel injection and a fuel injection system, wherein the fuel injection system comprises a fuel pump and a plurality of injection valves, each connected to a cylinder of an internal combustion engine, wherein the fuel pump and/or the injection valves produce pressure waves that cause fuel pressure fluctuations, and wherein depending on a respective current demanded fuel quantity in the internal combustion engine the fuel injection quantity is reduced or increased by using at least one actuator to produce additional pressure waves in the fuel injection system that modify the fuel pressure fluctuations with at least temporary boosting of said fuel pressure fluctuations.

### CROSS REFERENCE TO RELATED APPLICATIONS

The present application claims priority to German Patent Application No. 102013218358.5, filed Sep. 13, 2013, the entire contents of which are hereby incorporated by reference for all purposes.

### FIELD

The present disclosure relates to a method and system of operating an actuator positioned in a fuel system to generate additional pressure waves.

### BACKGROUND/SUMMARY

Common fuel rail injection systems may be used in various types of multiple cylinder engines. The fuel rail is supplied fuel by a pump to create a necessary pressure for the injector nozzles to inject fuel into the combustion chambers. The fuel to be injected is subject to the fuel distribution rail pressure in the fuel distribution rail and injection nozzle. Operation of the pump and fuel injectors produce pressure waves which result in fuel pressure fluctuations in the fuel injection system. The fuel pressure fluctuations cause undesirable fluctuations in the injected fuel quantities of the individual injection processes.

One approach to deal with fuel pressure fluctuations in a fuel system is shown by Ricci-Ottati et al in U.S. Pat. No. 6,345,606. Therein, a piezoelectric actuated fuel injector may be used to compensate pressure pulses within the common rail of the fuel injection system by adjusting or modulating the fuel flow rate through the control valve. During a decrease in fuel pressure, the piezo voltage is decreased, thereby decreasing the fuel flow rate through the conol valve and thus compensating for pressure pulses in the system. Another approach to deal with fuel pressure fluctuations in a fuel system is shown by Kensuke et al in JP 2005-163639A. Therein, a multistage injection is used to set up a timing between the pre-injections and main injection such that it becomes possible to inhibit surges in actual commanded injection quantites caused by pressure pulsation of the fuel dur to pre-injections. Thus, a specific injection pattern of pre-injections is used to suppress pressure pulsations during a multistage injection.

A potential issue with the above approach of Ricci-Ottati et al. is that the fuel flow rate during an injection is modified using the piezoelectric fuel injector in order to compensate for pressure pulses in the system. Thus, the method controls the rate shape of fuel injectors by varying the input signal which may not provide accurate rate shaping as is desirable. Another potential issue with the approach of Kensuke is that the timing of the pre-injections are set relative to the main injection for the purpose of compensating injector pressure waves. This does not allow a multistage injection system to be optimized for fuel delivery to the combustion chamber.

The inventors have recognized the above mentioned issue and developed a system and method for modifying the pressure fluctuations in the fuel system. The method for controlling the fuel injection of a fuel injection system, wherein the fuel injection system comprises a fuel pump and a plurality of injection valves, each connected to a cylinder of an internal combustion engine, wherein the fuel pump and/or the injection valves produce pressure waves that cause fuel pressure fluctuations, wherein, depending on a respective current fuel quantity demanded in the internal combustion engine, the fuel injection quantity is reduced or increased by using at least one actuator either to produce additional pressure waves in the fuel injection system that modify the fuel pressure fluctuations with at least temporary boosting of said fuel pressure fluctuations or to temporarily modify the average fuel pressure in the fuel injection system.

As an example, a setpoint fuel rail pressure may be set based on the engine load and engine speed such that the minimal allowed pulse width is not undershot. An actuator positioned in the fuel system may be activated to produce an additional pressure wave to temporarily modify the average fuel pressure in the fuel injection system to the setpiont fuel rail pressure. The activation of the actuator may be determined such that the timing of the injector may be optimized for the engine operating conditions.

In this way, an actuator may be positioned in the fuel injection system during selected conditions to modify the pressure fluctuations present in the fuel system wherein the pressure fluctuations are fuel pressure oscillations at a frequency of the high pressure pump and the injector or a harmonic thereof. By activating the actuator to produce additional pressure waves, a fuel system pressure may be achieved in a targeted manner. For example, the actuator may be activated before a fuel injection at a minimum pulse width to better enable more precise fuel metering. The use of the actuator allows for optimization of the fuel injection system and allows timing and pulse width to be set based on the engine operating conditions and not adjusted to compensate for fuel pressure fluctuations.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows an engine illustrating one cylinder of a multi-cylinder engine and a fuel system.

FIG. 2 schematically shows a fuel system according to an embodiment of the present disclosure.

FIG. 3 illustrates the variation between demanded fuel quantity and delivered fuel quantity per injection.

FIG. 4 graphically shows an example four cylinder injection fuel pressure fluctuations.

FIG. 5 illustrates an example of using an actuator to boost a pressure wave in a fuel system.

FIG. 6 illustrates an example of using an actuator to briefly change the current average pressure level of the fuel system.

FIG. 7 is a graphical representation of an example timeline for activation of an actuator in a fuel system for producing additional pressure waves.

FIG. 8 shows an example method for operating a fuel system with an actuator positioned therein.

FIG. 9 shows an example method for activating an actuator in a fuel system.

### DETAILED DESCRIPTION

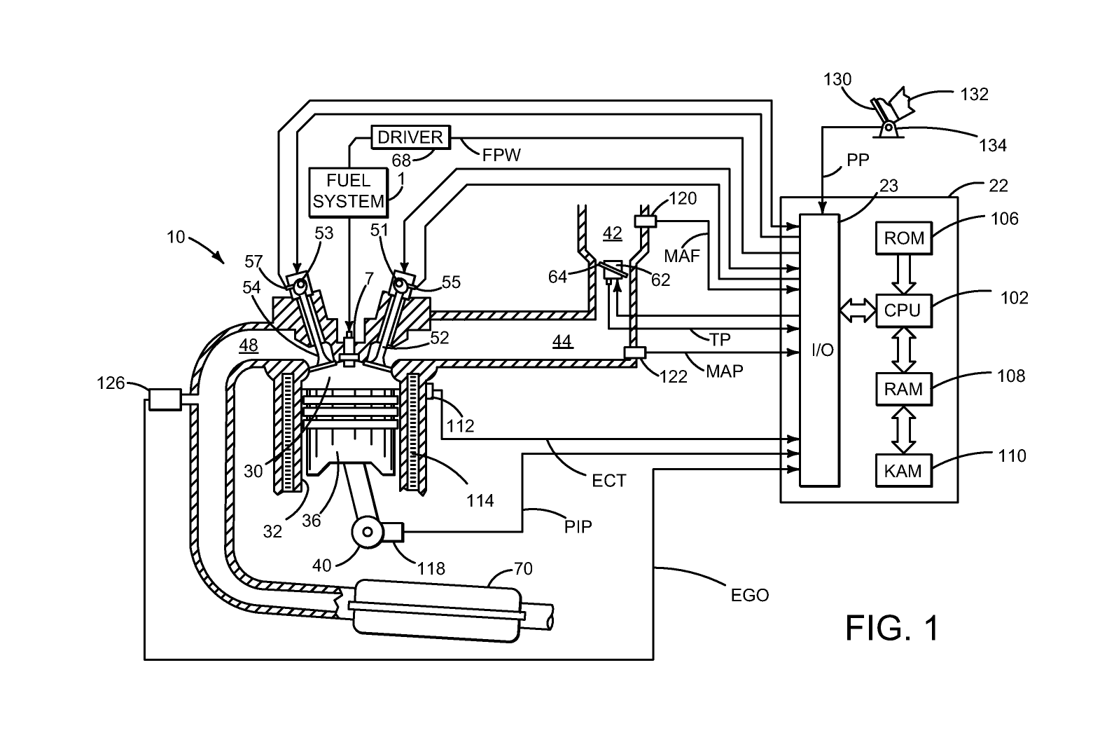

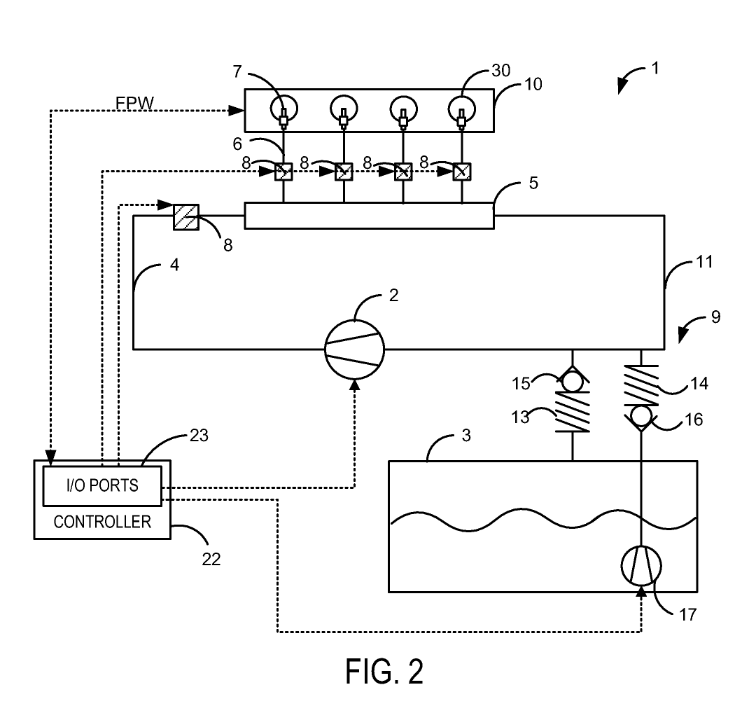

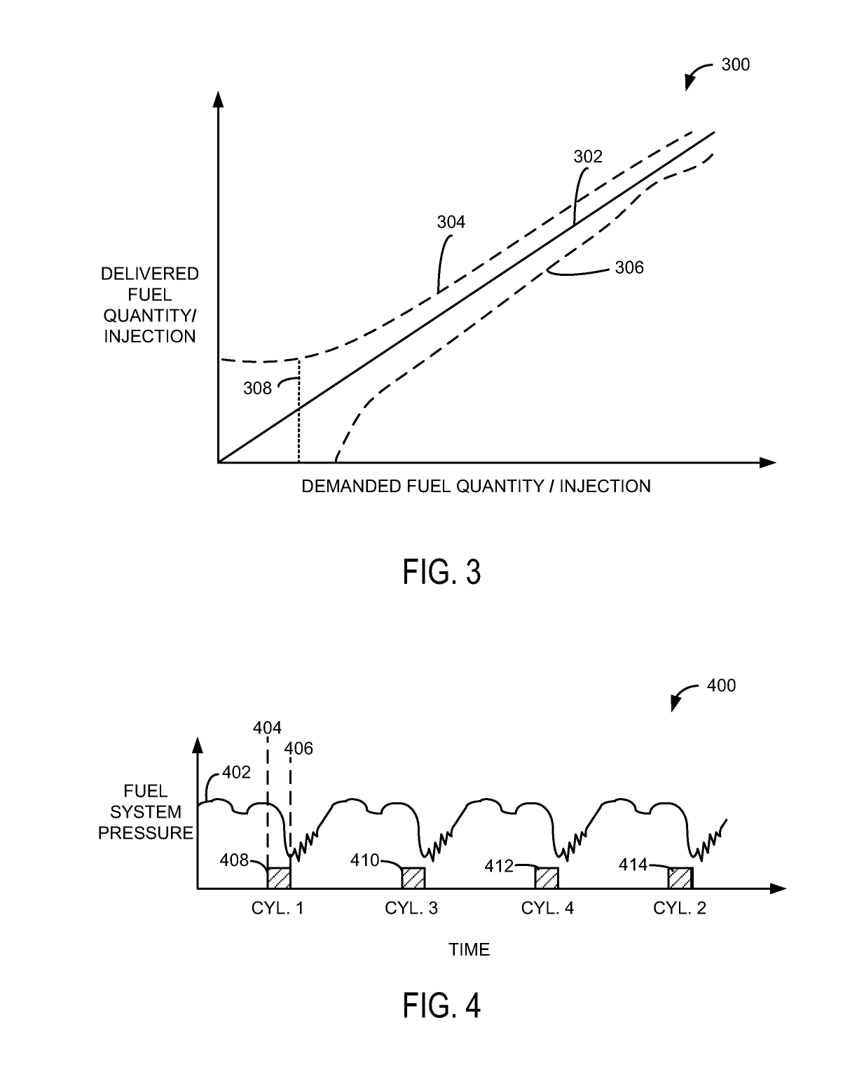

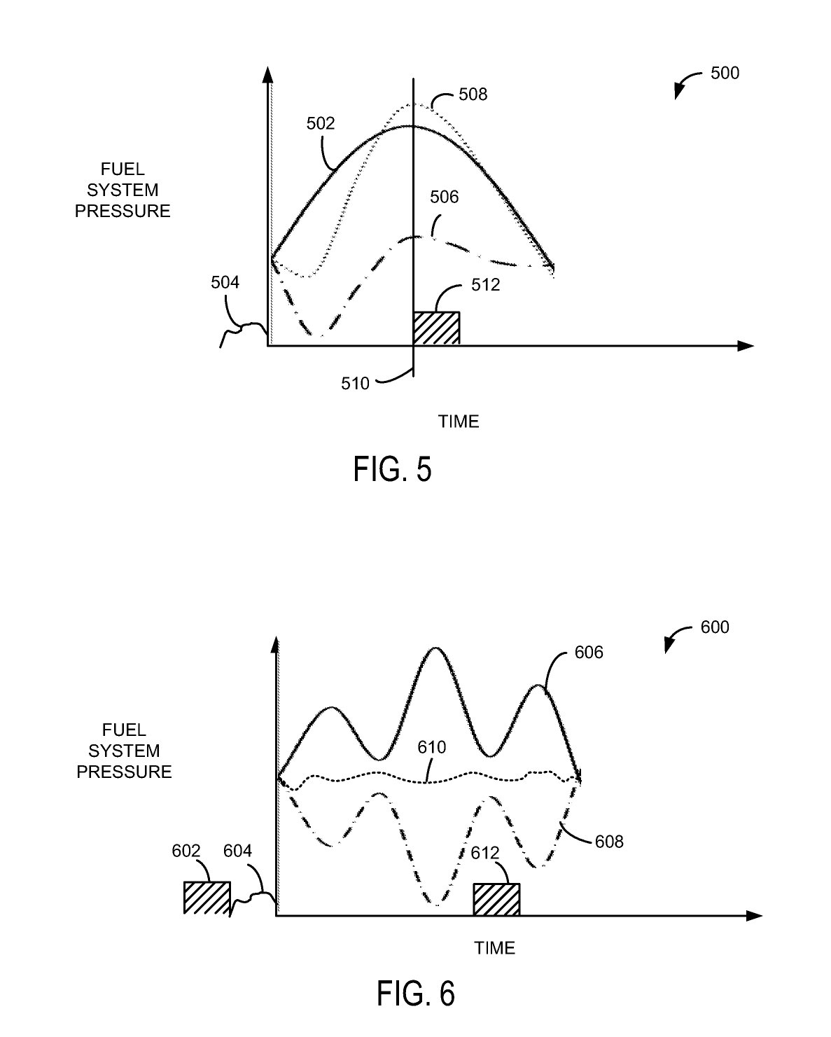

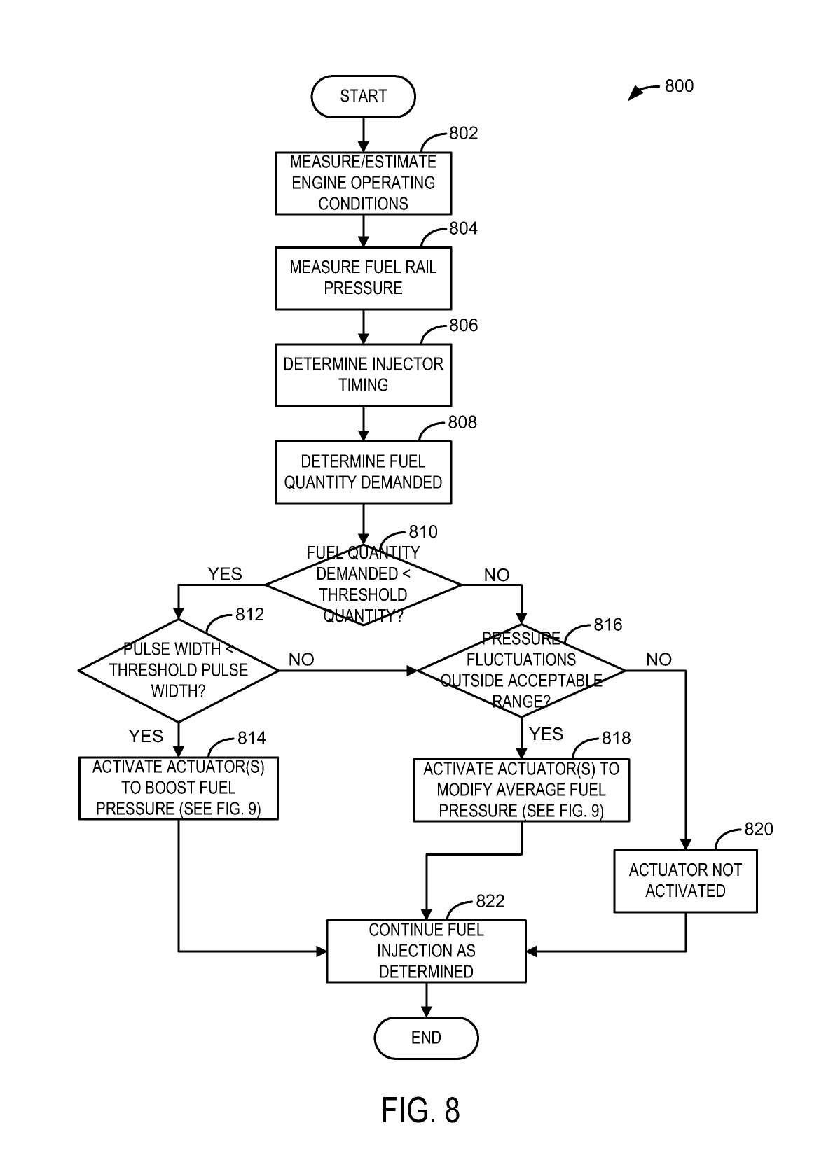

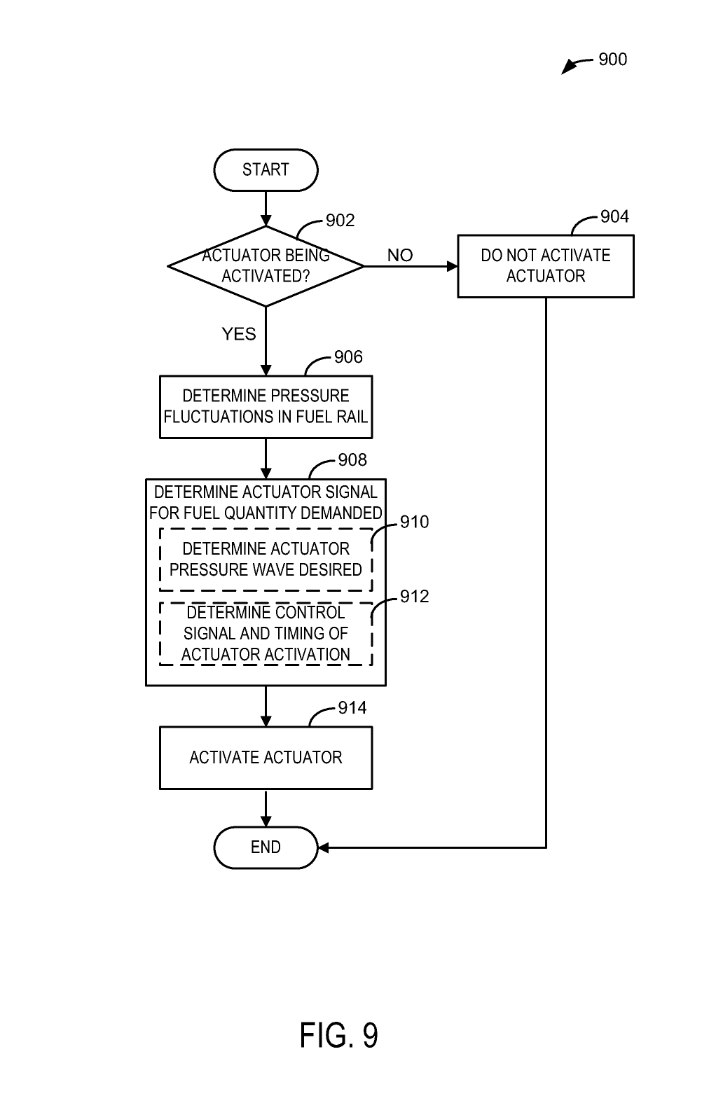

The present disclosure relates to a system and a method for controlling fuel injection and a fuel injection system. A fuel system in an internal combustion engine, illustrated in FIGS. 1 and 2, may have pressure fluctuations which occur during operation of the fuel system. These pressure fluctuations may cause undesirable fluctuations in the injected fuel quantity, as illustrated in FIGS. 3 and 4. An actuator positioned in the fuel system, illustrated in FIG. 2, may be activated to provide additional pressure waves in the fuel system to modify the pressure fluctuations and therefore the injected fuel quantity, as shown in FIGS. 5, 6, and 7. The actuator may be operated in response to fuel pressure fluctuations and a demanded fuel quantity, such as using the example methods shown in FIGS. 8 and 9.

During the operation of motor vehicles with a high pressure fuel injection system, the potential issue occurs that pressure waves may be caused by the opening and closing processes of the injection valve and also by the operation of the fuel pump and result in fuel pressure fluctuations and undesirable fluctuations of the injected fuel quantities of the individual injection processes. Such fuel pressure fluctuations may be particularly critical in such operating phases in which relatively small fuel quantities may be demanded, because the fuel pressure fluctuations then result in relatively large percentage variations in the injected fuel quantity.

A device and a method for damping pressure oscillations in a hydraulic line are known from DE 103 16 946 A1. Here an actuator e.g. having a piezo element is controlled by means of a control/regulation device such that pressure oscillations are formed that are at least approximately in anti-phase and are equal in amplitude to a pressure oscillation in the hydraulic line that is detected with sensor assistance and that is output by a pressure source. When the different pressure oscillations come together, elimination of the oscillation should be achieved in the ideal case by means of the superimposition that occurs.

It is an object of the present disclosure to provide a method and a device for the operation of a fuel injection system that better enables more precise fuel metering, especially in operating phases with relatively low demanded fuel quantity.

With a method according to the present disclosure for controlling the fuel injection of a fuel injection system, wherein the fuel injection system comprises a fuel pump and a plurality of injection valves, each connected to a cylinder of an internal combustion engine, and wherein the fuel pump and/or the injection valves produce pressure waves that cause fuel pressure fluctuations, depending on a respective current fuel quantity demanded in the internal combustion engine the fuel injection quantity is reduced or increased such that, using at least one actuator, additional pressure waves may be produced in the fuel injection system that modify the fuel pressure fluctuations with at least temporary amplification of said fuel pressure fluctuations or to briefly change the current average pressure level of the fuel system.

The present disclosure is especially based on the concept of manipulating fuel pressure fluctuations, which already occur as a result of the opening and closing processes of the injection valve or of the operation of the fuel pump, and the average pressure level by the targeted production of pressure waves in the fuel injection system so as to result in an increase in the precision of the fuel metering. This especially applies in operating phases in which the demanded fuel quantity is relatively low.

According to the present disclosure, hydraulic suppression or damping of fuel pressure fluctuations that exist in the conventional approach described above does not take place here, but the fuel pressure fluctuations that occur may be stabilized with temporary boosting or reduction and used in a controlled manner to amplify or reduce the fuel injection quantity depending on demand. For example, a controlled reduction of the fuel injection quantity may be desirable or advantageous in situations in which the minimal throughflow of the fuel injection valve or its variability is no longer sufficiently adjustable by controlling the injection valve.

The manipulation or control of the fuel metering according to the present disclosure may also be used to compensate injection valve variability, such as occur e.g. “from item to item” owing to manufacturing and aging, wherein regulating devices for regulating the fuel injection provided for such compensation, especially in conventional approaches, may be dispensed with.

The manipulation or control according to the present disclosure may especially be implemented using an actuator comprising at least one piezo element (e.g. in the form of a rapid piezo actuator or magnetic actuator), which produces pressure waves or an average pressure adjustment if this is currently considered for variation of the injected fuel quantity. The maxima and minima (“peaks” and “troughs”) in the variation may be used in a targeted manner here to increase or reduce the injected fuel injection quantity depending on demand.

Switches other than piezo elements or piezo switches may be used for producing the pressure waves. Thus in other embodiments a magnetorheological fluid or an electrorheological fluid may be used by causing a viscosity change or stiffening of the fluid by means of a variably applicable magnetic field or electric field in a conventional manner, and using said viscosity change or stiffening of the fluid to control an actuator that is used to produce the pressure waves.

In one example, electrorheological fluid may be an electrorheological suspension of polyurethane particles in silicon oil as a carrier fluid. In another example, a suspension of magnetically polarizable (e.g. iron) particles in a carrier fluid, e.g. a mineral oil or a synthetic oil, may also be used as a magnetorheological fluid.

As a result, according to the present disclosure pressure-wave-induced variations of the injected fuel quantity may be produced in a targeted manner and may be used to improve the accuracy of the fuel metering, especially where there is a demand for relatively small fuel quantities.

Other embodiments may be found in the following description and the dependent claims.

The present disclosure is explained below using an exemplary embodiment with reference to the accompanying FIGS.

FIG. 1 is a schematic diagram showing an example embodiment of one cylinder of multi-cylinder engine 10, which may be included in a propulsion system of an automobile. Engine 10 is controlled at least partially by a control system including controller 22 and by input from a vehicle operator 132 via an input device 130. In this example, input device 130 includes an accelerator pedal and a pedal position sensor 134 for generating a proportional pedal position signal PP.

Controller 22 is shown in FIG. 1 as a microcomputer, including microprocessor unit 102, input/output ports 23, an electronic storage medium for executable programs and calibration values shown as read-only memory chip 106 in this particular example, random access memory 108, keep alive memory 110, and a data bus. Controller 22 may receive various signals from sensors coupled to engine 10 including measurement of inducted mass air flow (MAF) from mass air flow sensor 120; engine coolant temperature (ECT) from temperature sensor 112 coupled to cooling sleeve 114; a profile ignition pickup signal (PIP) from Hall effect sensor 118 (or other type) coupled to crankshaft 40; throttle position (TP) from a throttle position sensor; and absolute manifold pressure signal, MAP, from sensor 122. Engine speed signal, RPM, may be generated by controller 22 from signal PIP. Manifold pressure signal MAP from a manifold pressure sensor may be used to provide an indication of vacuum, or pressure, in the intake manifold. Note that various combinations of the above sensors may be used, such as a MAF sensor without a MAP sensor, or vice versa. During stoichiometric operation, the MAP sensor may give an indication of engine torque, for example. Further, this sensor, along with the detected engine speed, may provide an estimate of charge (including air) inducted into the cylinder.

Storage medium read-only memory 106 may be programmed with computer readable data representing instructions executable by processor 102 for performing the methods described below as well as other variants that are anticipated but not specifically listed.

Combustion chamber (i.e., cylinder) 30 of engine 10 includes combustion chamber walls 32 with piston 36 positioned therein. As depicted, piston 36 is coupled to crankshaft 40 so that reciprocating motion of the piston is translated into rotational motion of the crankshaft. Crankshaft 40 may be coupled to at least one drive wheel of a vehicle via an intermediate transmission system. Further, a starter motor may be coupled to crankshaft 40 via a flywheel to enable a starting operation of engine 10.

As shown in the example of FIG. 1, combustion chamber 30 receives intake air from intake manifold 44 via intake passage 42 and exhausts combustion gases via exhaust passage 48. Intake manifold 44 and exhaust passage 48 may selectively communicate with combustion chamber 30 via respective intake valve 52 and exhaust valve 54. In some embodiments, combustion chamber 30 may include two or more intake valves and/or two or more exhaust valves.

In this example, intake valve 52 and exhaust valve 54 are controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 22 to vary valve operation. The positions of intake valve 52 and exhaust valve 54 are determined by position sensors 55 and 57, respectively. In alternative embodiments, intake valve 52 and/or exhaust valve 54 may be controlled by electric valve actuation. For example, cylinder 30 may alternatively include an intake valve controlled via electric valve actuation and an exhaust valve controlled via cam actuation including CPS and/or VCT systems.

As shown in FIG. 1, intake passage 42 includes a throttle 62 having a throttle plate 64. In this particular example, the position of throttle plate 64 may be varied by controller 22 via a signal provided to an electric motor or actuator included with throttle 62, a configuration that is commonly referred to as electronic throttle control (ETC). In this manner, throttle 62 may be operated to vary the intake air provided to combustion chamber 30 among other engine cylinders. The position of throttle plate 64 is provided to controller 22 by throttle position signal TP, for example. Intake passage 42 further includes a mass air flow sensor 120 and a manifold air pressure sensor 122 for providing respective signals MAF and MAP to controller 22.

In some embodiments, combustion chamber 30 or one or more other combustion chambers of engine 10 may be operated in a compression ignition mode, with or without an ignition spark. In other examples, engine 10 may additionally or alternatively include an ignition system which provides an ignition spark to combustion chamber 30 via a spark plug in response to a spark advance signal received from controller 22, under select operating modes.

Exhaust gas sensor 126 is shown coupled to exhaust passage 48 upstream of emission control device 70. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOₓ, HC, or CO sensor. Emission control device 70 is shown arranged along exhaust passage 48 downstream of exhaust gas sensor 126. Device 70 may be a three way catalyst (TWC), NOₓ trap, various other emission control devices, or combinations thereof. In some embodiments, during operation of engine 10, emission control device 70 may be periodically reset by operating at least one cylinder of the engine within a particular air/fuel ratio.

Fuel injector 7 is shown coupled directly to combustion chamber 30 for injecting fuel directly therein in proportion to the pulse width of signal FPW received from controller 22 via electronic driver 68. In this manner, fuel injector 7 provides what is known as direct injection of fuel into combustion chamber 30. The fuel injector may be mounted in the side of the combustion chamber or in the top of the combustion chamber (as shown in FIG. 1), for example. Fuel may be delivered to fuel injector 7 by fuel system 1 including a fuel tank, a fuel pump, and a fuel rail, as will be described in greater detail below with reference to FIG. 2. In some embodiments, combustion chamber 30 may alternatively or additionally include a fuel injector arranged in intake manifold 44 in a configuration that provides what is known as port injection of fuel into the intake port upstream of combustion chamber 30.

As described above, FIG. 1 shows only one cylinder of a multi-cylinder engine; it should be understood that each cylinder may similarly include its own set of intake/exhaust valves, fuel injector, spark plug, etc.

FIG. 2 is a schematic diagram showing an example design of a fuel injection system in the form of a common rail system. FIG. 2 shows an example of a fuel injection system 1 for an internal combustion engine 10, the system comprising a first fuel pump 2, which draws fuel from a fuel tank 3 and delivers the fuel under high pressure via at least one fuel pump line 4 towards at least one common fuel rail 5. Injector lines 6 feed the pumped fuel to fuel injectors 7 for supplying fuel for combustion in cylinders 30, such as the cylinder illustrated in FIG. 1, of the internal combustion engine 10.

From the common fuel rail 5 a fuel return line 11 is in fluid communication with the fuel tank 3 to return excess fuel to the tank. The return line 11 is coupled to the suction side of the first fuel pump 2, which in the exemplary embodiment shown is embodied as a high-pressure pump 2. In another example, the fuel system may be a returnless system.

The fuel return line 11 comprises a control element system 9, which as shown by way of example comprises a plurality of parallel valves 13 and 14. In this example embodiment, the valves 13, 14 comprise two parallel check valves, 15 and 16 respectively, which are configured to restrict flow in opposite directions. The first check valve 13 is arranged downstream of the second check valve 14 but upstream of the point where the fuel return line 11 is coupled to the fuel pump 2. Both check valves 13, 14 are connected to the fuel tank 3. The first check valve 13 is designed so that fuel pressure from the return line can be discharged to the fuel tank 3, and thus a fuel flow can occur to the fuel tank 3, when a calibrated fuel pressure threshold is reached or exceeded in the fuel return line 11. The second check valve 14 is designed so that no fuel can flow out of the fuel return line 11 into the fuel tank 3 and the fuel pressure in the fuel return line 11 is thereby maintained, when the internal combustion engine 10 stops. The second check valve 14 is designed so that fuel can flow from the fuel tank 3 towards and into the fuel return line 11 via a second, low pressure fuel pump 17 located within the fuel tank 3.

An actuator 8 is shown with possible positions on the fuel pump line 4 and/or the injector lines 6. In one example, only one actuator is included in the system. In another example, two or more actuators are included in the system. The actuator 8 is a separate actuator from the injector 7 actuators in the fuel system.

Pressure waves may be induced in the fuel injection system 1 both by the opening and closing processes of the injection valves 7, also referred to as injectors, and also by the operation of the fuel pump 2. According to the present disclosure, the fuel fluctuations caused in this way may be modified by means of at least one actuator 8 (which e.g. may be designed as a piezo switch and for which possible positions are indicated in FIG. 2 by way of example) producing additional pressure waves, by means of which the respective fuel quantity injected by means of the injection valves 7 depending on the currently demanded fuel quantity may be reduced or increased in a targeted manner. The fuel pressure fluctuations caused by the fuel pump 2 and/or the injection valves 7 may be temporarily modified in order to achieve precise fuel metering by the resulting stabilized fuel fluctuations or the resulting short-lived change of the average fuel pressure. The respective pressure fluctuations produced by the actuator 8 at defined points in time may be used in a targeted manner to increase or reduce the injection quantity. The actuator 8 may be located on the common rail 5 or the injection lines 6. The actuator 8 is not used to control the injection of fuel by the injectors 7.

FIG. 3 is an example graphical representation 300 of the demanded fuel quantity per injection versus the delivered fuel quantity per injection. Based on the demanded fuel quantity per injection, the controller may set a fuel pulse width and timing for the injector. The delivered quantity per injection should correlate to the demanded fuel quantity per injection in a linear fashion as illustrated by line 302. However, due to the pressure fluctuations in the fuel system, such as those which may be produced by operating the high pressure pump and/or the injector, the delivered quantity of fuel per injection shows variability for a given demanded quantity of fuel resulting in a range of delivered quantities as illustrated by an upper threshold range 304 and a lower threshold range 306. The range of delivered quantities may be larger at lower demanded quantities since the pressure fluctuations have a greater effect. Therefore, undesirable fluctuations of the injected fuel quantities for an injection process may cause an undesired quantity to be delivered to the combustion chamber via the injector. As the demanded fuel quantity per injection increases, the pressure fluctuations in the system affect the delivered quantity per injection less, as illustrated by the range of the upper threshold range 304 and lower threshold range 306 coming closer to line 302. For example, at a low demanded fuel quantity per injections, such as the demanded fuel quantity per injection at line 308, the delivered fuel quantity per injection may be a quantity along line 308. Therefore, fuel pressure fluctuations in the fuel system cause undesirable fluctuations in the delivered fuel quantity per injection and may cause a large percentage deviation between the demanded and delivered fuel quantity per injection.

FIG. 4 schematically shows an example trace 400 of the fuel system pressure fluctuations for an engine with four cylinders with a firing sequence of 1-3-4-2 as an example. In other examples, other firing sequences are possible, such as 1-2-4-3. Further, other numbers of cylinders and arrangements are possible. The fuel system pressure 402 shows fluctuations due to the pump operation. At 404, the first injector is opened to deliver fuel to cylinder 1. A pulse width 408 controls the opening duration of the injector. As the injector opens, the pressure in the fuel system drops at 404 due to fuel being removed from the fuel system and delivered to the combustion chamber. As the injector closes, the fuel system shows pressure fluctuations at a higher frequency than the noise from the pump at 406. These high frequency fluctuations may be from operating the injector. The fuel system pressure increases after the first injection as the pump operates. A similar fluctuation in the fuel system pressure is seen after a pulse width 410, 412, and 414 for the injections for the other cylinders. These fuel pressure fluctuations cause changes in the fuel system pressure which may result in the incorrect amount of fuel being delivered during subsequent injections. The fuel pressure fluctuations may have more importance at low demand fuel quantities, as illustrated in FIG. 3, and if the timing of the injections doesn't allow for the system to stabilize the fuel system pressure before the next injection. Thus, to better enable a delivered fuel quantity per injector which is closer to the demanded fuel quantity per injector, an actuator positioned in the fuel system, as illustrated in FIG. 2, may be used to modify the pressure fluctuations which occur in the fuel system.

FIGS. 5 and 6 graphically show using an actuator to generate additional pressure waves in a fuel system to modify the fuel system pressure and affect the quantity of fuel delivered per injection. The actuators may be positioned within the fuel system as illustrated in FIG. 2.

FIG. 5 illustrates an example graph 500 to modify the fuel pressure fluctuations in a fuel system by generating an additional pressure wave using an actuator positioned in the fuel system to temporarily boost said fuel pressure fluctuations. For example, boosting the pressure in the fuel system may increase the amount of fuel delivered during an injection and decrease the percentage variation in the injected fuel quantity from the demanded fuel quantity. This may be done when relatively low fuel quantities are demanded and such fuel pressure fluctuations cause undesirable fluctuations, which may cause large percentage deviations in the injected fuel quantity from the demanded fuel quantity. Curve 502 illustrates pressure fluctuation due to a high-pressure pump positioned in the fuel system. As the injector is opened at time 510 for a pulse width 512, an amount of fuel is delivered which may be less than the demanded quantity of fuel for this injection, in this example. The pulse width may be near the minimum pulse width and therefore a small fuel quantity is demanded. An actuator may be activated by the controller with a control signal 504 at a time before the injector is opened to produce an additional pressure wave 506 in the system. The additional pressure 506 wave interacts with the pressure wave 502 already present in the system to produce an overall pressure wave 508. In this example, the overall pressure wave 508 has a higher amplitude than pressure wave 508 at the time 510 the injector pulse width 512 starts. Thus, the fuel pressure fluctuation is temporarily boosted in the fuel system which may cause an increase in the fuel injection quantity and result in the delivered fuel quantity per injection being within an acceptable deviation of the demanded fuel quantity per injection. In this example, only one actuator is used to produce an additional pressure wave to boost the fuel pressure fluctuations due to operating the pump in the fuel system. In another example, more than one actuator may be used to produce multiple additional pressure waves to boost the fuel pressure fluctuation.

FIG. 6 illustrates an example graph 600 to modify the fuel pressure fluctuations in a fuel system by generating an additional pressure wave using an actuator positioned in the fuel system to temporarily modify the average fuel pressure in the fuel injection system. In this example, the pressure fluctuation 606 in the fuel system is from the pump and the injector being operated. When an injector closes, the injector pulse width 602 is finished, adding high frequency noise to the pump noise. The pressure fluctuation 606 may cause an undesirable fluctuation in a subsequent injection 612. An actuator may be activated by the controller with a control signal 604 in order to produce an additional pressure wave 608 to temporarily modify the average fuel pressure in the fuel injection system to produce an overall pressure wave 610. Thus, the overall pressure wave may be at an average fuel pressure which may result in the delivered quantity of fuel per injection being within an acceptable deviation of the demanded fuel quantity per injection. In this example, the injector pressure wave and pump pressure wave cause fuel pressure fluctuations which result in undesirable fluctuations in the injected fuel quantities. An actuator may be used to create additional pressure waves which reduce the undesirable fluctuations in the injected fuel quantities. This example illustrates activating an actuator to produce a fuel system pressure which reduces the amount of fuel delivered.

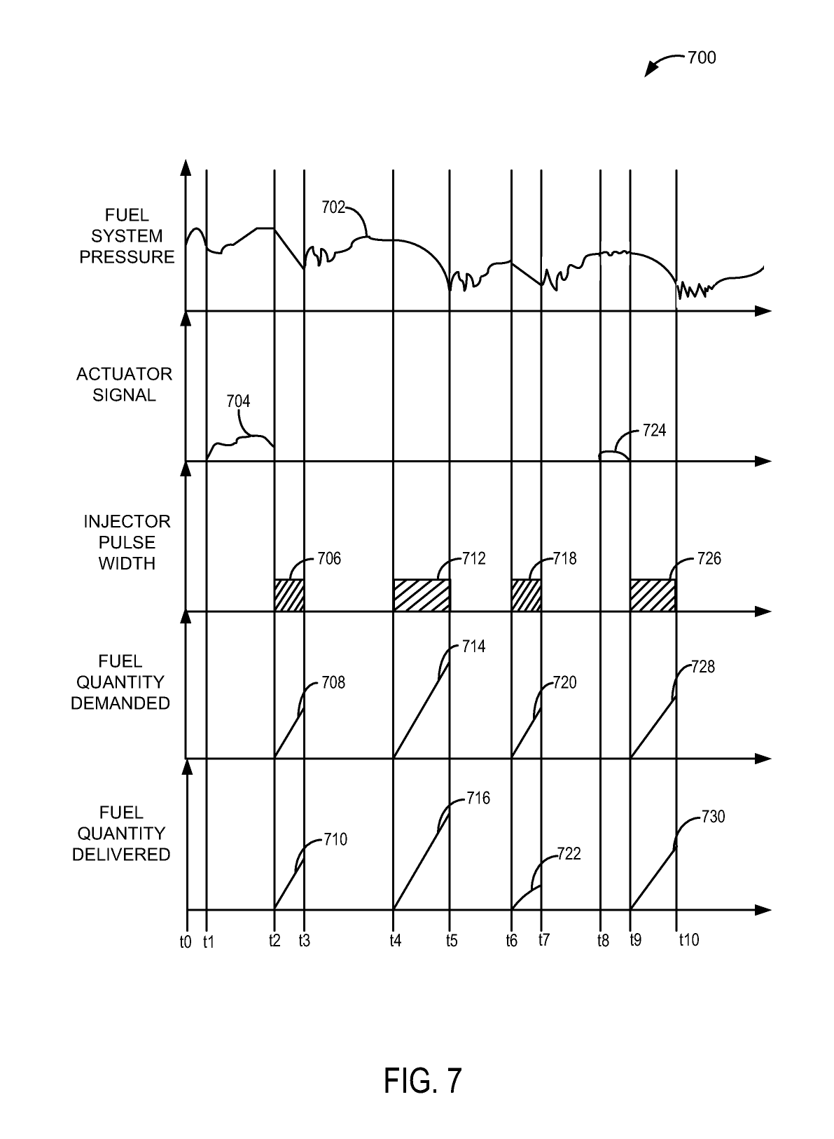

FIG. 7 shows an example map 700 of activating an actuator positioned in a fuel injection system to modify fuel pressure fluctuations in a fuel system to better enable a more precise fuel metering. Map 700 outlines various scenarios that may be encountered during engine operation and illustrated instances when an actuator may be activated to modify fuel pressure fluctuations. The map 700 illustrates the fuel system pressure 702, the actuator control signal 704, 724, the injector pulse width 706, 712, 718, 726, the fuel quantity demanded 708, 714, 720, 728 at each pulse width, and the fuel quantity delivered 710, 716, 722, 730 at each pulse width versus time.

During the time period t0 to t1, a fuel pressure fluctuation is shown in the fuel system pressure 702. The fuel pressure may fluctuate due to operation of the fuel pump and/or the injectors. The change in pressure in the fuel system may cause the fuel quantity delivered to show a percentage deviation from the fuel quantity demanded.

During the time period t1 to t2, an actuator is activated using a controller to provide an actuator control signal 704 in order to modify the fuel pressure fluctuations in the fuel system before an injection event to better enable the fuel quantity delivered to be within an acceptable range of the fuel quantity demanded. In this example, the actuator signal 704 is used to produce additional pressure waves which temporarily boost the fuel pressure fluctuations and therefore the fuel system pressure 702.

During the time period t2 to t3, an injector is opened and closed with an injector pulse width 706 in order to deliver fuel to a combustion chamber. In this example, the pulse width is at the minimum pulse width. The pulse width 706 occurs following the actuator control signal 704 in the previous time period t1 to t2. Thus, the fuel system pressure 702 was temporarily boosted at the time when the pulse width 706 was initiated and the injector opened. The increased pressure in the fuel system may increase the fuel quantity delivered 710 such that the delivered fuel quantity is equal to the fuel quantity demanded 708. For example, at a minimum pulse width with a low demanded fuel quantity, the pressure fluctuations present in the fuel system may cause a smaller quantity of fuel to be delivered than is demanded for the engine operating parameters. Thus, the air fuel ratio during the combustion event is not optimized. By increasing the fuel system pressure before the injection via an actuator positioned in the fuel system which produces an additional pressure wave to temporarily boost the system pressure better enables the fuel quantity demanded and delivered to have a low percentage variation, thereby optimizing the combustion process.

During the time period t3 to t4, fluctuations in the fuel system pressure 702 are illustrated which may occur following an injection event. The fuel system pressure 702 shows higher frequency fluctuations as well as low frequency fluctuations due to the injector closing and the pump operation. These pressure fluctuations in the fuel system pressure 702 may affect the fuel quantity delivered in subsequent injections. During the time period t4 to t5, a large quantity of fuel is demanded and a longer pulse width 712 is applied. The fuel quantity demanded 714 matches the fuel quantity delivered 716. For example, at larger demanded fuel quantities, the fuel system pressure fluctuations may have a lesser effect on the percentage of variation on the delivered fuel quantity since the injector is open for a longer time period. Thus, activation of an actuator may not be needed when a fuel quantity demanded is large.

During the time period t5 to t6, pressure fluctuations in the fuel system pressure 702 are illustrated which may occur after an injection event. Similar pressure fluctuations are seen as those described for time period t3 to t4.

During the time period t6 to t7, a low fuel quantity is demanded 720 at the minimum pulse width 718. During the time period and the previous time period the actuator was not activated. Therefore, no additional pressure waves to modify the pressure fluctuations in the fuel system were provided. The fuel quantity delivered 722 is seen to be less than the fuel quantity demanded 720. This is an example showing how the pressure fluctuations in the fuel system cause undesirable fluctuations in the fuel quantity delivered. Thus, the combustion efficiency of the engine may degrade due to an imprecise amount of fuel being injected to a combustion chamber.

During the time period t7 to t8, the fuel system pressure 702 is seen to change due to pressure fluctuations present from operation of the pump and injector as previously described.

During the time period t8 to t9, an actuator signal 724 is applied to the actuator to produce additional pressure waves in the fuel system to temporarily modify the average fuel system pressure in the fuel system. The fuel system pressure 702 is seen to be mostly constant with minimal fluctuations.

During the time period t9 to t10 an injector pulse width 726 is applied to the injector to deliver fuel to the combustion chamber. The fuel system pressure 702 at the start of the injections is mostly constant due to activation of the actuator to produce additional pressure waves during the previous time period. The fuel quantity delivered 730 is equal to the fuel quantity demanded 728. This is an example of a medium quantity of fuel being demanded. After time t10, the fuel system pressure 702 is built back up by the pump and shows pressure fluctuations due to the pump and the fuel injection.

FIG. 8 shows an example method 800 for operating a fuel injection system with an actuator positioned therein.

At 802 the method may measure and/or estimate the engine operating conditions. Operating conditions may include coolant temperature, ambient temperature and pressure, air-fuel ratio, etc.

At 804, the method may measure the fuel rail pressure. The fuel rail pressure may be measured using a pressure sensor positioned in the fuel system. In one example, the pressure sensor may be positioned upstream of the pump. In another example, the pressure sensor may be positioned in the fuel rail. The pressure may be measured over time to determine the pressure fluctuations present in the fuel system. In another example, a model may be used to calculate the pressure fluctuations present in the fuel system utilizing vehicle operating parameters.

At 806, the method may determine injector timing. The injector timing may be determined based on parameters such as desired air-fuel ratio, air and fuel mixing in the cylinder, intake valve timing, and the like.

At 808, the method may determine the fuel quantity demanded, the injection amount. The fuel quantity demanded may be determined based on desired air-fuel ratio, cam timing, and the like.

Once the fuel injection timing and the fuel quantity demanded are determine, the routine 800 proceeds to 810 where it is determined if the fuel quantity demanded is below a threshold fuel quantity. In one example, the threshold fuel quantity may be based on a set amount of fuel, such as an amount below which undesirable fluctuations in the delivered fuel quantity per injection result in a high percentage variation from the demanded fuel quantity per injection. In another example, the threshold fuel quantity may be set based on the engine speed and engine load.

If yes at 810, the fuel quantity demanded is less than a threshold fuel quantity, the method proceeds to 812. At fuel quantities demanded below the threshold fuel quantity, the pressure fluctuations present in the fuel system may cause a large deviation in the delivered fuel quantity, as illustrated in FIG. 3. At 812, the method may determine if the pulse width is less than a threshold pulse width. The threshold pulse width may be set to be near the minimum pulse width. If yes, the pulse width is less than a threshold pulse width, the method proceeds to 814 to activate the actuator(s) to boost the fuel pressure in this example method. For example, method 800 may boost a fuel pressure fluctuation present in the fuel system during a first condition. The first condition may comprise the pulse width at the minimum pulse width or a fuel quantity demand below a threshold quantity. In another example method, the fuel pressure may be modified to be at an average fuel pressure by activating the actuator. An example method of activating the actuator is shown in FIG. 9. The method may then proceed to 822 and continue the fuel injection as determined.

If no at 810, the fuel quantity demanded is not less than a threshold fuel quantity or if no at 812, the pulse width is not below a threshold pulse width, the method proceeds to 816. At 816, the method determines if the pressure fluctuations are outside of an acceptable range. For example, a pressure fluctuation with a high amplitude may be determined to be outside of the acceptable range. In another example, the average fuel pressure of the pressure fluctuations may be determined to be above or below the fuel pressure for the determined injector timing and fuel quantity. If no at 816, the method proceeds to 820 and the actuator is not activated. The method then proceeds to 822 and continues the fuel injection as determined.

If yes at 816, the pressure fluctuations are outside of the acceptable range, the method proceeds to 818 and activates the actuator(s) to modify the average fuel pressure. For example, during a second condition when the pressure fluctuations have an amplitude higher than a threshold amplitude, the actuator may be activated to produce an additional pressure wave which decreases the amplitude of the pressure fluctuations. In another example, the actuator may be activated to modify the average fuel pressure to an increased average value. The method may then continue the fuel injection as determined at 822.

Turning to FIG. 9, an example method 900 is shown to activate the actuator(s) in the fuel system. This method may be run at steps 814 and 818 of method 800, for example. Activating the actuator produces additional pressure waves which may be used in a targeted manner to more precisely deliver a fuel quantity per injection.

At 902, the method may determine if the actuator is being activated. If the actuator is not activated, the method proceeds to 904 and does not activate the actuator. The method then ends.

If at 902, the method determines the actuator is being activated, the method proceeds to 906. At 906, the method determines the pressure fluctuations in the fuel rail which will be modified. In one example, stored wave forms may be used in order to determine the pressure fluctuations which may be present in the fuel system.

At 908, the method may determine an actuator signal for the fuel quantity demanded. This may include at 910 determining the actuator pressure wave desired to modify the pressure fluctuations in the fuel system and at 912 determining the control signal and timing of the control signal for actuator activation. For example, if method 800 determines the actuator is being activated to boost the fuel system pressure, the method 900 at 908 may determine an actuator signal which modifies the fuel system pressure to increase.

At 914, the method may activate the actuator with the determined actuator signal at the determined timing to produce an additional pressure wave in the system which modifies the pressure fluctuations in the fuel system in a targeted manner such that a quantity of fuel delivered may be equal to a quantity of fuel demanded.

In this way, an actuator may be provided in a fuel system to produce additional pressure waves to modify fuel pressure fluctuations in the fuel system to better enable more precise fuel metering during fuel injection at certain operating conditions. This allows for the combustion process to be optimized for a demanded fuel quantity. The actuator may be operated as needed to deliver a demanded fuel quantity during a fuel injection. Thus, the fuel metering of the fuel injection system may be optimized using at least one actuator positioned in the fuel system by producing additional pressure waves.

The actuation of the piezoelectric actuator in the fuel system can be controlled in various ways. For example, the actuator actuation timing may be selected to have a frequency in common with fuel pump and/or injector activation operation as well as a phase that causes pressure waves to add together, where timing of the injector activation (e.g., on time) occurs during the peak of the adding waveforms to provide increased pressure. Under other conditions, the actuation timing may still have the common frequency but a different phase that cancels the peaks of the waves so that the injector fuel pressure is lower or has a minimum valve that is lower than it otherwise would be and the injector can be activated during this lower duration to reduce the amount of fuel injected for the given injector on time. In this way, the turn down ratio or dynamic range of the injector can be increased without necessarily making large changes in the average rail pressure, and further in such a way that the next injector to fire can still have a pressure at a desired value without having to change the average rail pressure so that a quick change in effective rail pressure is achieved, even from one combustion event to the next.

Note that the example control and estimation routines included herein can be used with various engine and/or vehicle system configurations. The control methods and routines disclosed herein may be stored as executable instructions in non-transitory memory. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for controlling the fuel injection of a fuel injection system, wherein the fuel injection system comprises a fuel pump and a plurality of injection valves, each connected to a cylinder of an internal combustion engine, wherein the fuel pump and/or the injection valves produce pressure waves that cause fuel pressure fluctuations, wherein:
depending on a respective current fuel quantity demanded in the internal combustion engine, the fuel injection quantity is reduced or increased by using at least one actuator either to produce additional pressure waves in the fuel injection system that modify the fuel pressure fluctuations with at least temporary boosting of said fuel pressure fluctuations or to temporarily modify the average fuel pressure in the fuel injection system.

2. The method as claimed in claim 1, wherein the actuator comprises at least one piezo element.

3. The method as claimed in claim 1, wherein the actuator is controlled or regulated by a magnetorheological fluid or an electrorheological fluid.

4. The method as claimed in claim 1, wherein the actuator comprises at least one magnetic actuator.

5. A method for a fuel injection system including a high pressure pump, an actuator, and an injector, comprising:
activating the actuator positioned between the injector and the pump to produce an additional pressure wave to modify pressure fluctuations in the fuel system, the additional pressure wave at a frequency of the high pressure pump and the injector and/or a harmonic thereof.

6. The method of claim 5, wherein activating the actuator includes generating the additional pressure wave at a determined phase relative to activation of the injector.

7. A method for a fuel system, comprising:
during a first condition temporarily boosting a fuel pressure by actuating an actuator upstream of an injector; and
during a second condition temporarily reducing the fuel pressure by actuating the actuator upstream.

8. The method of claim 7, wherein the first condition comprises a fuel quantity demanded below a threshold quantity.

9. The method of claim 8, wherein the second condition comprises an amplitude of the fuel pressure fluctuations being greater than a threshold amplitude.

10. A method for a fuel injection system with a fuel rail for supplying fuel to multiple injectors, comprising:
determining a fuel pressure fluctuation in the fuel system;
determining an injection timing and pulse width;
determining a fuel quantity demanded; and
modifying the fuel pressure fluctuation and the injection timing by producing an additional pressure wave via an actuator in the fuel system.

11. The method of claim 10, wherein the additional pressure wave boosts the fuel pressure fluctuation.

12. The method of claim 10, wherein the additional pressure wave modifies the average fuel pressure.

13. The method of claim 10, wherein the actuator is activated by a piezo element to produce the additional pressure wave.
